(19) United States
(12) Patent Application Publication
(10) Pub. No.: US 2025/0180922 A1
(43) Pub. Date: Jun. 5, 2025

(54) FLEXIBLE BRIDGE ASSEMBLY FOR RIMLESS EYEWEAR

(71) Applicant: BRENT SHELDON, MIAMI, FL (US)

(72) Inventors: BRENT SHELDON, MIAMI, FL (US); GUY BROUSSEAU, JR., MARIEVILLE (CA)

(21) Appl. No.: 18/950,537

(22) Filed: Nov. 18, 2024

Related U.S. Application Data
(63) Continuation of application No. PCT/CA2023/050688, filed on May 18, 2023.
(60) Provisional application No. 63/343,174, filed on May 18, 2022.

(51) Int. Cl. G02C 1/02; G02C 5/08; G02C 5/12

(52) U.S. Cl. CPC G02C 1/02; G02C 5/08; G02C 5/12

(57) ABSTRACT

A flexible bridge assembly for a rimless eyewear is provided. The flexible bridge assembly includes a body comprising a first flexible mounting portion and a second flexible mounting portion, each extending from opposite ends of a flexible central portion. The flexible bridge assembly also includes a first rigid mounting member embedded in the first mounting portion and configured to enable securing of the flexible bridge assembly to a first lens of the rimless eyewear. The flexible bridge assembly further includes a second rigid mounting member embedded in the second flexible mounting portion and configured to enable securing of the flexible bridge assembly to a second lens of the rimless eyewear. Further, the flexible bridge assembly includes a deformable rigid bar extending between the first and second mounting members and configured to be embedded within the flexible central portion.

### CROSS-REFERENCE TO RELATED APPLICATIONS

This application is a Continuation of PCT Application No. PCT/CA2023/050688 filed on May 18, 2023, which claims priority from U.S. Provisional Patent Application No. 63/343,174 filed on May 18, 2022, the contents of which are incorporated herein by reference in their entirety.

### TECHNICAL FIELD

The following relates to flexible bridge assemblies for rimless eyewear.

### BACKGROUND

Eyewear such as eyeglasses generally include a frame that supports one or more lenses. The frame typically includes a nose bridge or nose pieces that engage the user's nose to support the eyewear on the user's head. Eyeglasses also typically include a pair of arms attached to (or integral with) the frame, to further support the eyeglasses, e.g., by resting the arms on the user's ears or engaging their head in the temple region. Other eyewear may include other support elements such as straps or bands (e.g., in sports goggles). These frames can include rims that surround the lenses, or can be connected directly to the lenses in multiple components, providing a “rimless” configuration.

Eyeglasses have traditionally utilized frames or frame components made from substantially rigid materials such as plastics, metals, or composite materials. The rigidity of these materials supports the lenses with the frames, and substantially maintains the shape of the eyeglasses such that they consistently fit on a user's head as intended. A drawback of this rigidity is that the frames can only typically withstand some flexure and can be prone to breakage or deformation.

Flexible components have been used in eyewear, for example, flexible arms and flexible portions of the eyewear frames. Various challenges can arise in construction, assembly, and use when incorporating flexible elements. For example, the flexibility should not cause the frames to deform and thus lose their shape over time. Other challenges include assembly complexities and costs associated with using multiple different materials.

It is an object of the following to address at least one of the above-noted disadvantages.

### SUMMARY

In a first aspect, a flexible bridge assembly for a rimless eyewear is provided. The flexible bridge assembly includes a body comprising a first flexible mounting portion and a second flexible mounting portion, each extending from opposite ends of a flexible central portion. The flexible bridge assembly also includes a first rigid mounting member embedded in the first mounting portion and configured to enable securing of the flexible bridge assembly to a first lens of the rimless eyewear. The flexible bridge assembly further includes a second rigid mounting member embedded in the second flexible mounting portion and configured to enable securing of the flexible bridge assembly to a second lens of the rimless eyewear. Further, the flexible bridge assembly includes a deformable rigid bar extending between the first and second mounting members and configured to be embedded within the flexible central portion.

In another aspect, a rimless eyewear is provided. The rimless eyewear includes first and second lenses, first and second arm mounting components coupled to a first end of a respective one of the first and second lenses, and first and second arms coupled to the first and second arm mounting components. The rimless eyewear also includes a flexible bridge assembly coupled to the first and second lenses. The flexible bridge assembly includes a body comprising a first flexible mounting portion and a second flexible mounting portion, each extending from opposite ends of a flexible central portion. The flexible bridge assembly also includes a first rigid mounting member embedded in the first mounting portion and configured to enable securing of the flexible bridge assembly to a first lens of the rimless eyewear. The flexible bridge assembly further includes a second rigid mounting member embedded in the second flexible mounting portion and configured to enable securing of the flexible bridge assembly to a second lens of the rimless eyewear. Further, the flexible bridge assembly includes a deformable rigid bar extending between the first and second mounting members and configured to be embedded within the flexible central portion. Furthermore, the rimless eyewear includes first and second nose pieces extending from or coupled to the flexible bridge portion.

### BRIEF DESCRIPTION OF THE DRAWINGS

Embodiments will now be described with reference to the appended drawings wherein:

FIG. 1 is a perspective view of rimless eyewear with a flexible bridge assembly;

FIG. 2 is an enlarged partial perspective view of the flexible bridge assembly shown in FIG. 1;

FIG. 3 is an enlarged partial perspective view of a portion of the flexible bridge assembly shown in FIG. 2;

FIG. 4 is a partial perspective view of the flexible bridge assembly, with transparency used to illustrate interior components, including a deformable rigid bar extending between the first and second mounting members;

FIG. 5a is a plan view of the flexible bridge assembly shown in FIG. 4, with transparency used to illustrate interior components;

FIG. 5b is a plan view of the flexible bridge assembly shown in FIGS. 4 and 5a, illustrating flexure of the flexible bridge assembly;

FIG. 6 is a cross-sectional view of the flexible bridge assembly shown in FIG. 5 along line VI-VI;

FIG. 7 is a partial perspective view illustrating flexure of the flexible bridge assembly in one direction;

FIG. 8 is a partial perspective view illustrating flexure of the flexible bridge assembly in another direction;

FIG. 9 is a perspective view of the flexible bridge assembly in isolation;

FIG. 10 is an exploded perspective view of the rimless eyewear shown in FIG. 1; and

FIG. 11 is an enlarged front view of a portion of a lens shown in FIG. 10.

### DETAILED DESCRIPTION

According to various embodiments of this disclosure, to provide flexibility in eyewear, for example, rimless eyeglasses, a flexible bridge assembly can be provided. The flexible bridge assembly includes rigid mounting members and a deformable rigid bar contained or embedded within a flexible body that includes a flexible central portion for allowing flexibility about the bridge assembly. Including such a deformable rigid bar adds to or otherwise customizes the resistance to flexure of the flexible bridge assembly. Similarly, the deformable rigid bar, via its inherent elastic deformability and resilience, can further encourage a return to rest for the overall eyewear assembly after being flexed. Further, the deformable rigid bar can also connect to the rigid mounting members to connect otherwise separate parts and facilitate aligning and holding them in place during assembly (e.g., during an overmolding process) to further assist in the accuracy and efficiency of such a process. Moreover, shape memory and other alloys can be used to enable a user to customize or otherwise adjust the rest position of the flexible portion, e.g., by including a slight bend to accommodate the specific user.

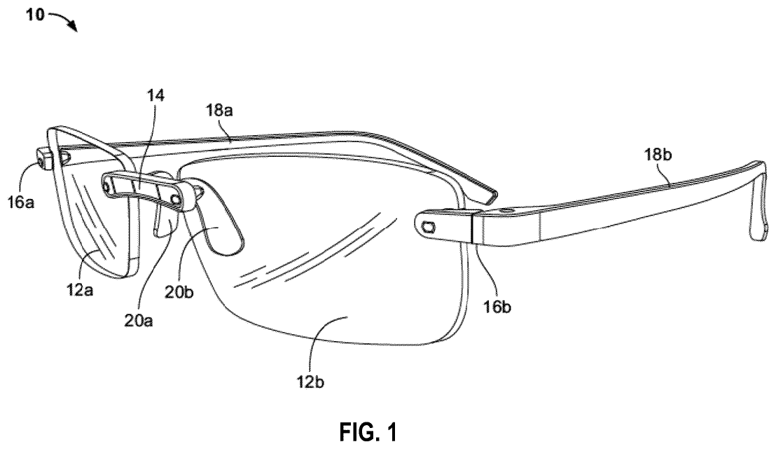

Turning now to the figures, FIG. 1 provides a perspective view of an example assembled rimless eyewear 10, also referred to interchangeably herein as a rimless eyewear assembly 10 or rimless eyewear 10 or eyewear 10 for brevity. The rimless eyewear 10 includes a pair of lenses 12, in this example a first lens 12a and a second lens 12b. The lenses 12a, 12b are supported in a “rimless” configuration and thus frame components are attached directly to the lenses 12a, 12b rather than encircling and retaining them. The lenses 12a, 12b are connected to each other, for example, via a flexible bridge assembly 14 that includes or otherwise supports first and second nose pieces 20a, 20b. A first arm 18a is connected directly to the first lens 12a via a first arm mounting component 16a, and a second arm 18b is connected directly to the second lens 12b via a second arm mounting component 16b. Each of the first and second arm mounting components 16a, 16b can include hinges to permit the respective arms 18a, 18b to be folded relative to the lenses 12a, 12b, as is known in the art.

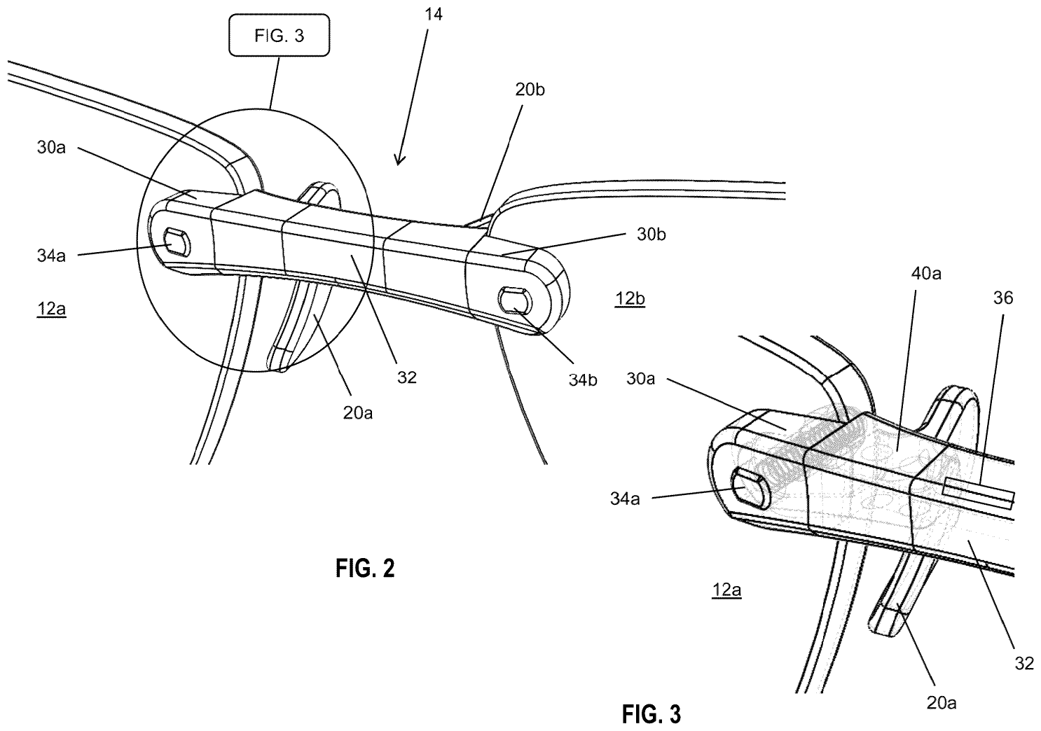

Additional details of the flexible bridge assembly 14 are illustrated in FIGS. 2 and 3. As illustrated in FIG. 2, the flexible bridge assembly 14 is connected to the lenses 12 via a pair of fasteners 34, which can be, for example, a screw, bolt, post, rivet, or any other suitable fasteners. In this example, a first fastener 34a is used to connect a first mounting portion 30a of the flexible bridge assembly 14 to the first lens 12a, and a second fastener 34b is used to connect a second mounting portion 30b of the flexible bridge assembly 14 to the second lens 12b. In some implementations, the mounting portions 30a, 30b may be formed integrally with a flexible central portion 32 of the flexible bridge assembly 14, which provides a desired separation between the lenses 12a, 12b when assembled as shown in FIG. 2. In some other implementations, the mounting portions 30a, 30b may be separate components that may be coupled to the flexible central portion 32 by suitable fastening mechanisms. The flexible material comprising the flexible first and second mounting portions 30a, 30b extending from either end of the flexible central portion 32 may also be referred to herein as a flexible body or body generally, or collectively the “flexible material”.

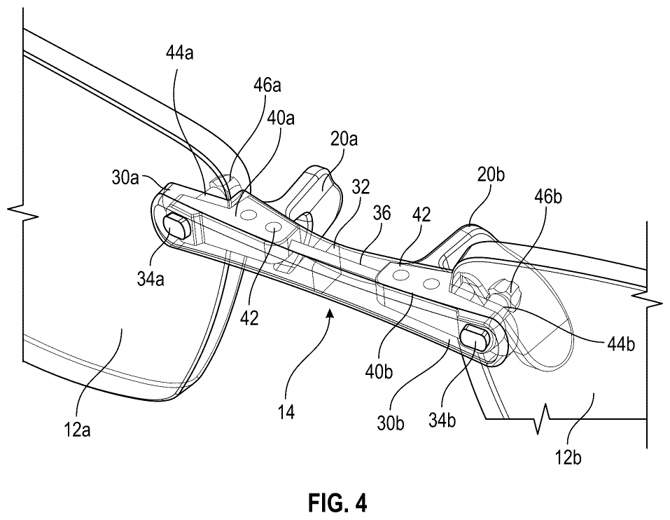

In FIG. 3, the transparency illustrates that the first nose piece 20a, in this example, is an extension of a first mounting member 40a that is embedded or otherwise included within the first mounting portion 30a of the flexible bridge assembly 14. While not shown in FIG. 3 (but shown in FIG. 4), it can be appreciated that in this example, the second nose piece 20b is an extension of a second mounting member 40b that is embedded or otherwise included within the second mounting portion 30b of the flexible bridge assembly 14. In an embodiment, as seen in FIG. 3, a deformable but rigid bar 36, hereinafter referred to as the deformable rigid bar 36, is also included within the flexible bridge assembly 14. In one implementation, the deformable rigid bar 36 extends between the first and second mounting members 40a, 40b, as will be discussed in greater detail later. As will be explained in greater detail below, the mounting members 40 are made from a rigid material to provide stability and support for the eyewear 10 when the flexible bridge assembly 14 is attached to the lenses 12a, 12b. The other material that forms the first and second mounting portions 30a, 30b and the flexible central portion 32 is preferably overmolded on the mounting members 40a, 40b and the deformable rigid bar 36 to create the flexible bridge assembly 14 that can then be assembled with the lenses 12a, 12b in constructing the eyewear.

In an example implementation, the construction of the flexible bridge assembly 14 can be done using any suitable overmolding process. Overmolding, sometimes referred to as two times injection molding, is a process where a single part is created using two or more different materials in combination. Typically, a first material (or a substrate) is partially or fully covered by overmolded material during the manufacturing process. In this case, the rigid mounting members 40a, 40b and the deformable bar 36 act as the substrate that is overmolded with the material used to create the flexible mounting portions 30a, 30b and the flexible central portion 32 thereon. In some implementations, the material used for creating the flexible mounting portions 30a, 30b and the flexible central portion 32 may include, but not limited to, a softer plastic, rubber, thermoplastic rubber (TRP), thermoplastic polyurethane (TPU), elastomer (e.g., PTE), or any other suitable material known in the art. It can be appreciated that the flexible material may be overmolded to the rigid mounting members 40a, 40b, and the deformable rigid bar 36 prior to attaching the flexible bridge assembly 14 to the lenses 12a, 12b. That is, the flexible bridge assembly 14 may, in some examples, be constructed as a separate component that is incorporated into the assembly process. Further, in some implementations, the rigid components described herein may be made of rigid material, such as, but not limited, hard plastic, metal, or composite material.

FIG. 4 illustrates further detail of the mounting hardware used in this example. The first fastener 34a, in this example, is embodied as a bolt having an unthreaded shaft 44a that includes a portion of threading, and that receives a first nut 46a on the rear side of the first lens 12a. Similarly, the second fastener 34b has an unthreaded shaft 44a that includes a portion of threading, and that receives a second nut 46b on the rear side of the second lens 12b.

FIG. 4 also illustrates the deformable rigid bar 36, which, in this example, extends through the flexible central portion 32 between the first and second rigid mounting members 40a, 40b embedded within the flexible bridge assembly 14. In some example implementations, the deformable rigid bar 36 can be made from an elastically deformable metal that is capable of being bent while returning to its original shape. Due to its inherent rigidity, the deformable rigid bar 36 provides strength to the flexible central portion 32 while being embedded within the otherwise flexible central portion 32 that may be overmolded as discussed above. In this way, the deformable rigid bar 36 can be chosen to have a thickness and material to fine tune the flexibility of the flexible central portion 32 while reforming to its original shape after being flexed as illustrated herein. In some implementations, a rigidity factor of the eyewear may be determined and a suitable thickness and material for the deforming rigid bar 15 may be identified to satisfy the determined rigidity factor.

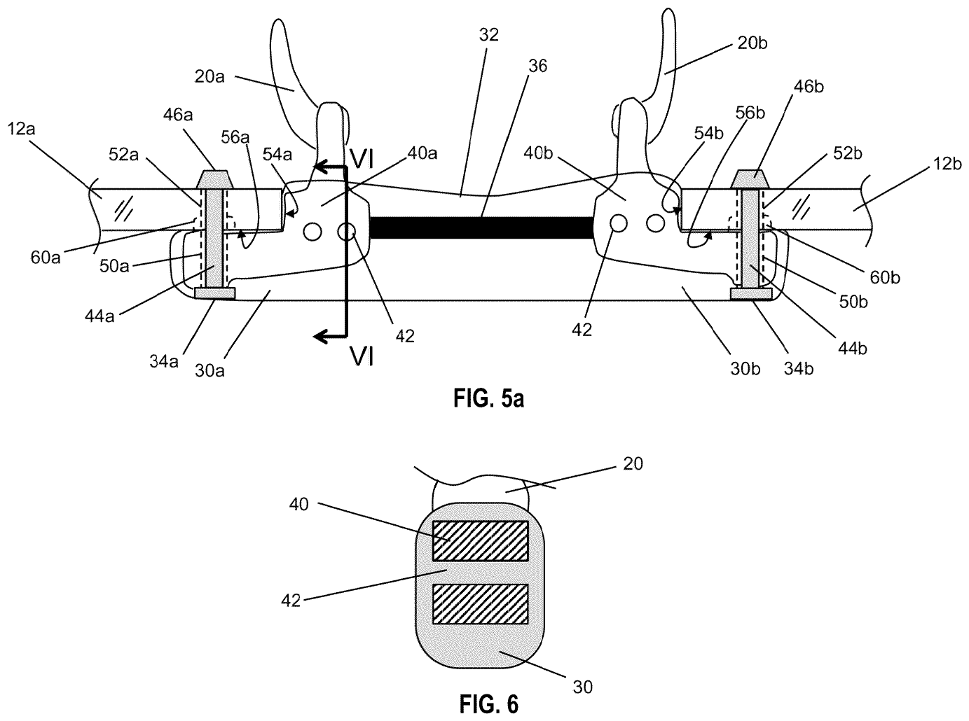

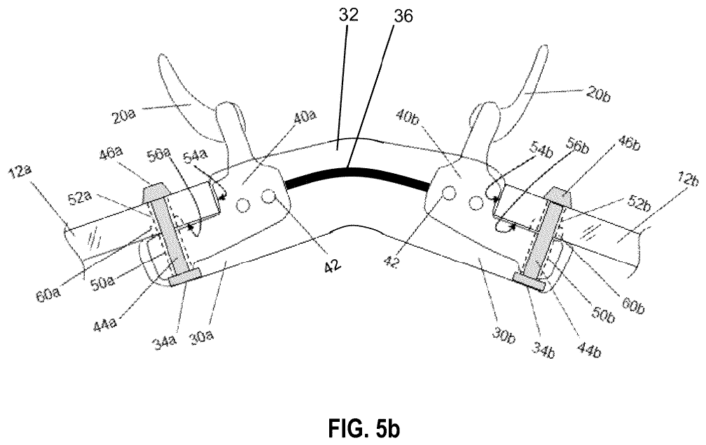

Turning now to the plan view shown in FIG. 5a, in some implementations, the mounting members 40a, 40b are overmolded or otherwise incorporated into the flexible bridge assembly 14 such that they provide rigid surfaces that bear against faces and edges of the lenses 12a, 12b. For example, the first mounting member 40a includes a first edge bearing surface 54a that seats with and engages an inner edge portion of the first lens 12a, and a first face bearing surface 56a that seats with and engages an outwardly facing portion of the front face of the first lens 12a. This effectively provides a notch or recess in the flexible bridge assembly 14 for the first lens 12a. Similarly, the second mounting member 40b includes a second edge bearing surface 54b that seats with and engages an inner edge portion of the second lens 12b, and a second face bearing surface 56b that seats with and engages an outwardly facing portion of the front face of the second lens 12b. This provides a notch or recess in the flexible bridge assembly 14 for the second lens 12b.

In some implementations, the “notches” provided in the flexible bridge assembly 14 also serve to align a first mounting passage 50a with a first lens passage 52a for inserting the first fastener 34a for securing the flexible bridge assembly 14 to the first lens 12a. Similarly, this allows a second mounting passage 50b to be aligned with a second lens passage 52b for inserting the second fastener 34b for securing the flexible bridge assembly 14 to the second lens 12b. It can be appreciated that the overmolded flexible material can be configured to allow the heads of the first and second fasteners 34a, 34b to be at least partially countersunk as illustrated in FIG. 5a. Similarly, the amount of overmolded material can be varied to suit different styles and aesthetics.

It can also be observed from FIG. 5a that, in some implementations, the mounting members 40a, 40b can be provided with one or more holes 42 for the overmolding process. This is further illustrated in the cross-sectional view in FIG. 6 wherein the overmolded material of the mounting portion 30 flows through the hole 42 during the overmolding process and fills this hole 42, when cured, to provide additional gripping and encapsulation of the mounting member 40. It can be appreciated that two holes 42 are shown in FIG. 5a for illustrative purposes only and any one or more holes can be used. FIG. 5a also illustrates the deformable rigid bar 36 that extends between the first and second mounting members 40a, 40b. It can be appreciated that the deformable rigid bar 36 is shown as a separate and distinct piece in FIG. 5a for illustrative purposes only and that the deformable rigid bar 36 can also be integrally constructed with the first and second mounting members 40a, 40b to provide a single piece that is overmolded to form the flexible bridge assembly 14. In an embodiment, the deformable rigid bar 36 includes a separate material from that of the mounting members 40a, 40b to provide the elastic deformability and resilience as discussed above. In some examples, the deformable rigid bar 36 can be attached to the mounting members 40a, 40b as illustrated in FIG. 5a, while in some other examples, the deformable rigid bar 36 may define or have a small separation or gap with the mounting members 40a, 40b. Further, by being embedded within the flexible material of the flexible central portion 32, any flexure of the flexible central portion 32 will likewise flex the deformable rigid bar 36, with any additional rigidity or resistance to the flexure imparted on the flexible central portion 32. When attached, the deformable rigid bar 36 can be fastened, welded, fused, or otherwise coupled thereto. FIG. 5b illustrates the flexure of the deformable rigid bar 36 as the flexible central portion 32 is flexed. As noted above, when released, the deformable rigid bar 36 returns to its original shape shown in FIG. 5a.

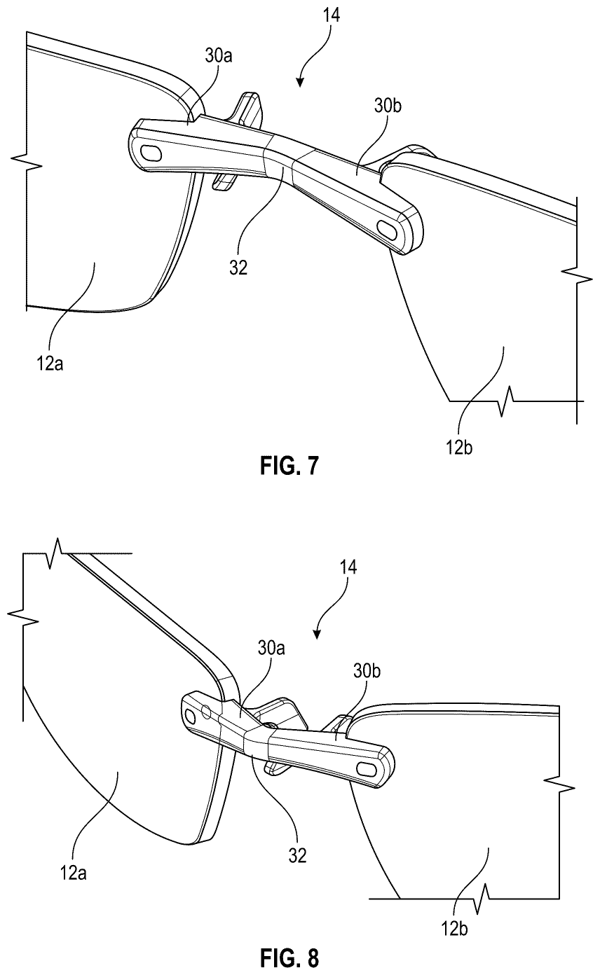

In an embodiment, the softer and flexible overmolded material that extends from the mounting portions 30a, 30b and through the flexible central portion 32 creates a flexible bridge assembly for the eyewear 10. The flexible central portion 32 (and the flexible bridge assembly) enables the eyewear 10 to be flexed such that the rigid lenses 12a, 12b and arms 18a, 18b attached thereto can be bent or otherwise separated or twisted relative to each other. This allows, for example, a user to slightly flex the arms 18a, 18b away from each other when placing the eyewear 10 on their head, with resiliency in the flexible central portion 32 causing the arms 18a, 18b to return towards each other and seat against the user's head and on their ears. This flexibility also resists breakage of the rigid components by permitting them to flex, twist and to a certain extent fold, e.g., if the eyewear 10 falls, is sat-upon by the user, is stuffed into a purse or bag, etc. This flexibility is illustrated in FIGS. 7 and 8, in which FIG. 7 shows flexure of the flexible central portion 32 allowing the arms 18a, 18b to be further separated. FIG. 8 shows flexure of the flexible central portion 32 in the other direction, allowing the lenses 12a, 12b and arms 18a, 18b to be compressed towards each other without damaging the eyewear 10.

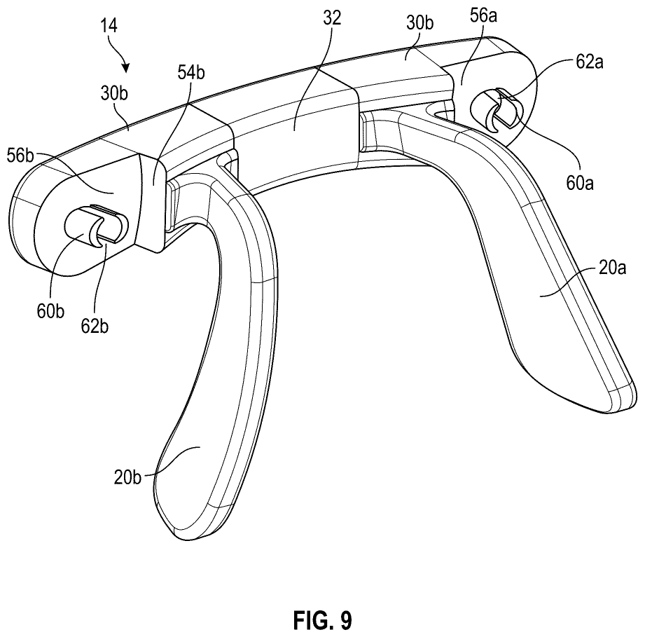

The example flexible bridge assembly 14 is shown in isolation in FIG. 9, from the rear view. In this view, it can be seen that the amount of overmolded material in the notched areas of the first and second mounting portions 30a, 30b is minimal or none to provide relatively rigid surfaces 54, 56 to engage with the lenses 12. The nose pieces 20a, 20b are integral with the mounting members 40a, 40b, in this example, and may extend from the overmolded material. However, it can be appreciated that the nose pieces 20a, 20b could instead be constructed separately and coupled to the flexible bridge assembly 14 using fastening mechanisms. For example, posts (not shown) could be included which extend from the overmolded material and provide mounting areas for separate nose pieces (also not shown). In either configuration, the nose pieces 20a, 20b can be made from a flexible or deformable material that provides adjustability, and if applicable, can provide mounting areas for nose pads (not shown).

Also shown in FIG. 9 are first and second alignment tabs 60a, 60b that, for example, also extend from the overmolded material and conform to the shape of at least a portion of the first and second lens passages 52a, 52b. Referring also to FIG. 6, in some implementations, the tabs 60a, 60b can be sized to extend into a slot or countersunk portion of the passages 52a, 52b. These tabs 60a, 60b can include slots 62a, 62b that provide some resiliency to have the flexible bridge assembly 14 “snap” into the lens passages 52a, 52b. The tabs 60a, 60b (and slot or countersunk passage in lenses 12a, 12b) can also be oblong in shape, rather than circular, to inhibit rotation of the lenses 12a, 12b about the tabs 60a, 60b.

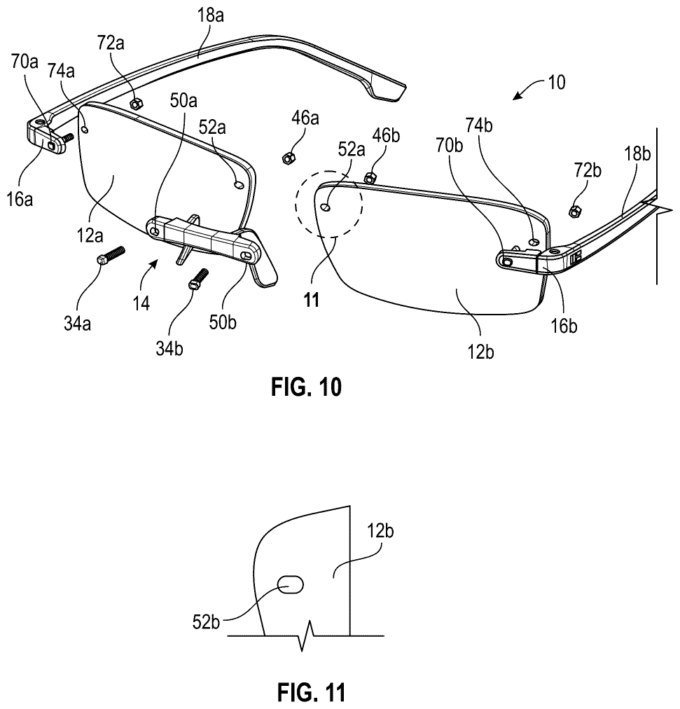

The exploded view in FIG. 10 illustrates the various components that are assembled to construct the eyewear 10 according to the embodiments described herein. In an example, the fasteners 34a, 34b are inserted through the flexible bridge assembly 14 and the respective lens passages 52a, 52b are secured with the first and second nuts 46a, 46b. As indicated above, the shape (e.g., oblong shape) of the tabs 60a, 60b and the corresponding shape of the passages 52a, 52b serves to align the lenses 12a, 12b relative to the flexible bridge assembly 14. In some implementations, as shown in FIG. 10, a first arm fastener 70a is fed through a first arm mounting passage 74a at the outer end of the first lens 12a that is secured with a third nut 72a to assemble the first arm 18a. Similarly, a second arm fastener 70b is fed through a second arm mounting passage 74b at the outer end of the second lens 12b that is secured with a fourth nut 72b to assemble the second arm 18b. FIG. 11 provides an enlarged view of an example of the second lens passage 52b to illustrate the corresponding shape of that passage 52b to accommodate insertion of the second tab 60b and to inhibit rotation and thus align the second lens 12b with the flexible bridge assembly 14. The other lens passages 52a, 74a, 74b can be similarly shaped for the same purpose.

While the foregoing discusses the use of overmolding as a preferred method of incorporating the rigid mounting members 40a, 40b in and with the flexible bridge assembly 14, it can be appreciated that other methods could instead be used. For example, the flexible mounting portions 30a, 30b could include a slot or cavity that is sized to receive the rigid mounting members 40a, 40b and deformable bar 36 in the way illustrated in FIG. 5a. In this example, the rigid mounting members 40a, 40b and deformable bar 36 could be bonded to the flexible material to construct the flexible bridge assembly 14. This can be done prior to, or subsequent to mounting the mounting members 40a, 40b on the lenses 12a, 12b.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

Although the above principles have been described with reference to certain specific examples, various modifications thereof will be apparent to those skilled in the art as outlined in the appended claims.

1. A flexible bridge assembly for a rimless eyewear, the flexible bridge assembly comprising:
a body comprising a first flexible mounting portion and a second flexible mounting portion, each extending from opposite ends of a flexible central portion;
a first rigid mounting member embedded in the first mounting portion and configured to enable securing of the flexible bridge assembly to a first lens of the rimless eyewear;
a second rigid mounting member embedded in the second flexible mounting portion and configured to enable securing of the flexible bridge assembly to a second lens of the rimless eyewear; and
a deformable rigid bar extending between the first and second mounting members and configured to be embedded within the flexible central portion.

2. The flexible bridge assembly of claim 1, wherein the first flexible mounting portion and first rigid mounting member comprise a first passage to enable the flexible bridge assembly to be secured to the first lens of the rimless eyewear, and the second flexible mounting portion and the second rigid mounting member comprise a second passage to enable the flexible bridge assembly to be secured to a second lens of the eyewear.

3. The flexible bridge assembly of claim 1, wherein the body is overmolded over the first and second mounting members and the deformable rigid bar.

4. The flexible bridge assembly of claim 3, wherein the first and second rigid mounting members each comprise at least one hole for receiving material applied in overmolding the body.

5. The flexible bridge assembly of claim 1 further comprising first and second nose pieces, wherein the first nose piece is integral with the first rigid mounting member and the second nose piece is integral with the second rigid mounting member, the nose pieces extending from the first and second flexible mounting portions of the body.

6. The flexible bridge assembly of claim 1, wherein the first and second flexible mounting portions of the body are countersunk to accommodate fasteners for securing the flexible bridge assembly to the lenses.

7. The flexible bridge assembly of claim 1, wherein the first and second rigid mounting members each comprise a tab surrounding the first and second passages, the tabs being configured to be inserted into portions of the corresponding passages in lenses of the eyewear.

8. The flexible bridge assembly of claim 7, wherein the tabs comprise slits to provide resiliency during insertion.

9. The flexible bridge assembly of claim 7, wherein the tabs include an oblong shape that corresponds to an oblong shape of the portion of the corresponding passages in the lenses of the eyewear.

10. The flexible bridge assembly of claim 1, wherein the first and second flexible mounting portions of the body are configured to define notches aligned with surfaces of the first and second rigid mounting members to engage with edges and faces of the lenses.

11. A rimless eyewear comprising:
first and second lenses;
first and second arm mounting components coupled to a first end of a respective one of the first and second lenses;
first and second arms coupled to the first and second arm mounting components;
a flexible bridge assembly coupled to the first and second lenses, the flexible bridge assembly comprising:
a body comprising a first flexible mounting portion and a second flexible mounting portion, each extending from opposite ends of a flexible central portion;
a first rigid mounting member embedded in the first mounting portion and configured to enable securing of the flexible bridge assembly to a first lens of the rimless eyewear;
a second rigid mounting member embedded in the second flexible mounting portion and configured to enable securing of the flexible bridge assembly to a second lens of the rimless eyewear;
a deformable rigid bar extending between the first and second mounting members and configured to be embedded within the flexible central portion; and
first and second nose pieces extending from or coupled to the flexible bridge assembly.

12. The rimless eyewear of claim 11, wherein the first flexible mounting portion and the first rigid mounting member comprise a first passage to enable the flexible bridge assembly to be secured to the first lens using a first fastener, and the second flexible mounting portion and the second rigid mounting member comprise a second passage to enable the flexible bridge assembly to be secured to the second lens using a second fastener.

13. The rimless eyewear of claim 11, wherein the body is overmolded over the first and second rigid mounting members and the deformable rigid bar.

14. The rimless eyewear of claim 13, wherein the body is overmolded over the first and second rigid mounting members prior to coupling the flexible bridge assembly to the first and second lenses.

15. The rimless eyewear of claim 13, wherein the first and second rigid mounting members each comprise at least one hole for receiving material applied in overmolding the body.

16. The rimless eyewear of claim 11, wherein the first and second flexible mounting portions of the body are countersunk to accommodate fasteners for securing the flexible bridge assembly to the lenses.

17. The rimless eyewear of claim 11, wherein the first and second rigid mounting members each comprising a tab surrounding the first and second passages, the tabs being configured to be inserted into portions of the passages in the lenses.

18. The rimless eyewear of claim 17, wherein the tabs comprise slits to provide resiliency during insertion.

19. The rimless eyewear of claim 17, wherein the tabs comprise an oblong shape that corresponds to an oblong shape of the portions of the corresponding passages in the lenses.

20. The rimless eyewear of claim 11, wherein the first and second flexible mounting portions of the body are configured to provide notches aligned with surfaces of the first and second rigid mounting members to engage with edges and faces of the lenses.
